(19) United States
(12) Patent Application Publication
(10) Pub. No.: US 2024/0296241 A1
(43) Pub. Date: Sep. 5, 2024

(54) DEVICE FOR DRIVING SECURITY TOOL SYSTEM PROVIDING FOLDER PROTECTION FUNCTION, AND METHOD FOR OPERATING SAME

(71) Applicant: KIWONTECH CO., LTD., Seoul (KR)

(72) Inventor: Chung Han KIM, Seoul (KR)

(21) Appl. No.: 18/549,577

(22) PCT Filed: Jul. 30, 2021
(86) PCT No.: PCT/KR2021/009940

§ 371 Date: Sep. 7, 2023

(51) Int. Cl. G06F 21/62

(52) U.S. Cl. CPC G06F 21/6218

(57) ABSTRACT

A method for operating a driving device for driving a security tool system according to one embodiment of the present invention comprises: an encoding step for generating changed tree structure information by changing an original folder tree structure in accordance with an encoding process of the security tool system; a folder structure managing step for managing folder structure change information of the security tool system on the basis of the changed tree structure information; and a changing step for changing the path of a file reading command requested from inside the security tool system, on the basis of the folder structure change information.

### TECHNICAL FIELD

The present invention relates to a driving device and a method thereof. More specifically, the present invention relates to a driving device of a security tool system for providing a folder protection function and an operating method thereof.

### BACKGROUND ART

Generally, an operating system performs a function of efficiently managing system hardware and software resources and coordinating data processing and work plans. A file system, which is a subsystem of the operating system, may provide a data management system capable of searching for and accessing data such as files stored in a system. Such a file system may be provided in various types with its own characteristics according to the operating system. For example, file systems in Windows-based operating systems are typically provided as File Allocation Table 32 (FAT32), New Technology File System (NTFS), or the like. File systems in Unix and Linux operating systems are provided as a Unix File System (UFS) and an Extended File System (EXT), respectively, and file systems for Mac OS are provided as an Apple file system (APFS).

File systems may logically manage data stored in a storage device so that hardware resources and software resources may be efficiently managed through the operating system. File systems may store data in a space of a specific storage device and provide a data management system that accesses the stored data to call. The data management system of such a file system may be systematized as a folder (directory) structure. The folder structure may be hierarchically structured like a tree structure.

Through this, the folder structure may be used as a location path for execution of a system management process of an operating system and a specific application program. In addition, the folder structure may provide a storage location path of a data file that are required to be read (called) in executing a process of an operating system, an application program, or the like to access the data file.

In relation to this, when a hacker who infiltrates the internal network through hacking with a malicious intention or a user who accesses a security tool system through a targeted email attack, spear phishing, or the like grasps in advance even the data management system, which is the folder structure of the security tool system, confidential data may be leaked easily, or a threat of abnormally operating the security tool system may be generated.

Particularly, since folder systems are usually the same or similar in the case of security system equipment of the same company, it is possible to incapacitate target equipment and easily steal files by analyzing the same or similar equipment of the company.

Although the security threat elements like this may be sold by applying a different folder system structure to each equipment, it is difficult to attempt as it takes time and money every time and facilities for constructing infrastructures and management costs for central management are added.

In addition, when the folder system structure is leaked, a security system engineer should be dispatched and change the system structure, but since it should be carried out for each individual equipment, excessive time and cost may be consumed. When the folder system structure is leaked, it is desirable to periodically change the folder system, but similarly, a security system engineer should be dispatched and change the system structure in the same way, and since it should be carried out for each individual equipment, excessive time and cost are consumed, so that such a method has a limit in reality.

### DISCLOSURE OF INVENTION

### Technical Problem

Therefore, the present invention has been made in view of the above problems, and it is an object of the present invention to provide a driving device of a security tool system and an operation method thereof, which provide a folder protection function that can control access and execution of a process within the security tool system in order to block harmful effects and illegal behaviors of leakage, falsification, and destruction of data that may be applied to the internal information system by an external intruder or an internal user having a malicious intention, who exploits information on the data management system in the security tool system to incapacitate the system.

### Technical Solution

To accomplish the above object, according to one aspect of the present invention, there is provided a driving method of a driving device that drives a security tool system, the method comprising: an encryption processing step of generating conversion tree structure information by converting an original folder tree structure according to an encryption process of the security tool system; a folder structure management step of managing folder structure conversion information of the security tool system on the basis of the conversion tree structure information; and a conversion processing step of converting a path of a file reading command requested from the inside of the security tool system on the basis of the folder structure conversion information.

According to another aspect of the present invention, there is provided an email security service providing device comprising: a folder structure management unit for managing folder structure conversion information of a security tool system; and a conversion processing unit for converting a path of a file reading command requested from inside of the security tool system on the basis of the folder structure conversion information.

Meanwhile, the method according to an embodiment of the present invention for solving the problems may be implemented as a program for executing the method or a computer-readable recording medium in which the program is recorded.

### Advantageous Effects

According to an embodiment of the present invention, as the folder system structure, which is a data management system, can be dynamically converted against hackers or internal users who access a security tool system of an internal network with a malicious intention, normal security functions of the security tool system can be guaranteed and the internal information system can be protected from intruders by enhancing security of the folder system structure applied to the security tool system to operate by default. In addition, security enhancement can be maximized by allowing a manager to execute conversion of the folder system structure of the security tool system periodically or as needed through a user interface. As the folder system structure can be dynamically converted without visiting the site by a manufacturer's engineer or security equipment expert, the time required for changing settings can be minimized, and cost can be reduced.

### BRIEF DESCRIPTION OF THE DRAWINGS

FIG. 1 is a conceptual view schematically showing the entire system according to an embodiment of the present invention.

FIG. 2 is a block diagram showing a driving device according to an embodiment of the present invention in more detail.

FIG. 3 is a flowchart illustrating an operation method of a driving device according to an embodiment of the present invention.

### BEST MODE FOR CARRYING OUT THE INVENTION

Hereinafter, only the principles of the present invention will be exemplified. Therefore, although not clearly described or shown in this specification, those skilled in the art will be able to implement the principles of the present invention and invent various devices included in the spirit and scope of the present invention. In addition, it should be understood that all conditional terms and embodiments listed in this specification are, in principle, clearly intended only for the purpose of understanding the concept of present invention, and not limited to the embodiments and states specially listed as such.

In addition, it should be understood that all detailed descriptions listing specific embodiments, as well as the principles, aspects, and embodiments of the present invention, are intended to include structural and functional equivalents of such matters. In addition, it should be understood that such equivalents include equivalents that will be developed in the future, as well as currently known equivalents, i.e., all devices invented to perform the same function regardless of the structure.

Accordingly, for example, the block diagrams in the specification should be understood as expressing the conceptual viewpoints of illustrative circuits that embody the principles of the present invention. Similarly, all flowcharts, state transition diagrams, pseudo code, and the like may be practically embodied on computer-readable media, and it should be understood that regardless of whether or not a computer or processor is explicitly shown, they show various processes performed by the computer or processor.

Functions of various devices shown in the drawings including functional blocks displayed as processors or concepts similar thereto may be provided using hardware capable of executing software in relation to appropriate software, as well as dedicated hardware. When provided by a processor, the functions may be provided by a single dedicated processor, a single shared processor, or a plurality of individual processors, and some of these may be shared.

In addition, explicit use of the terms presented as processors, controls, or concepts similar thereto should not be interpreted by exclusively quoting hardware having an ability of executing software, and should be understood to implicitly include, without limitation, digital signal processor (DSP) hardware, and ROM, RAM and non-volatile memory for storing software. Other known common hardware may also be included.

Components expressed in the claims of this specification as means for performing the functions described in the detailed description are intended to include all methods performing the functions including, for example, a combination of circuit devices performing the functions or all types of software including firmware/microcode and the like, and combined with suitable circuits for executing the software to perform the functions. Since the present invention defined by these claims is combined with the functions provided by variously listed means and combined with methods required by the claims, any means that can provide these functions should be understood as being equivalent to those grasped from this specification.

The above objects, features and advantages will become more apparent through the following detailed description related to the accompanying drawings, and accordingly, those skilled in the art may easily implement the technical spirit of the present invention. In addition, when it is determined in describing the present invention that the detailed description of a known technique related to the present invention may unnecessarily obscure the gist of the present invention, the detailed description thereof will be omitted.

Hereinafter, preferred embodiments of the present invention will be described in more detail with reference to the accompanying drawings. In describing the present invention, in order to facilitate the overall understanding, the same reference numerals are used for the same components in the drawings, and duplicate descriptions of the same components are omitted.

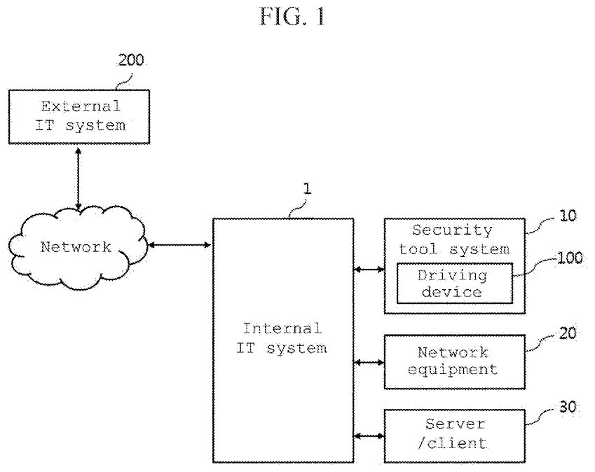

FIG. 1 is a conceptual view schematically showing the entire system according to an embodiment of the present invention.

The entire system including a security tool system that provides a folder protection function according to an embodiment of the present invention may include an internal IT system 1 and an external IT system 200. In addition, the internal IT system 1 may include a security tool system 10, a network equipment 20, and a server/client 30.

The internal IT system 1 may be configured to be independent from an external network in a communication path branched through the external network (Internet network). At this point, the internal IT system 1 may secure a communication path independent from the external network through communication equipment (not shown) such as an Internet gateway router or the like, and construct an additional IT infrastructure under the Internet gateway router through this. The internal IT system 1 may be configured to include the security tool system 10, the network equipment 20, and the server/client 30 for moving, sharing, and processing data, and utilize IT resources.

At this point, the security tool system 10 may include an information protection equipment or system capable of blocking unauthorized person's access or preventing inflow of abnormal data from an external network. Specifically, the security tool system 10 may include a network firewall, web firewall, anti-DDOS, network access control (NAC), intrusion prevention system (IPS), spam mail blocking system, and the like.

Here, the driving device 100 according to an embodiment of the present invention may be an operation control device mounted on the security tool system 10 to control driving of the security tool system 10, and may be configured of one or more hardware modules for this purpose and software modules for operating the same. For example, the driving device 100 may include one or more microprocessor-based circuits in which a software operating system that operates the network firewall, web firewall, anti-DDOS, network access control (NAC), intrusion prevention system (IPS), spam mail blocking system, and the like according to driving of the security tool system 10 is implemented in hardware.

In addition, the network equipment 20 may be configured as equipment that performs functions of designating and expanding communication paths, such as a router, a switch, a hub, and the like.

In addition, the server may be divided into a mail server, a web server, a web application server, a DB server, and the like, and the client may be divided into user terminals such as a PC, a terminal, and the like.

The external IT system 200 is an unspecific IT system connected to the external network, through which requested services of moving, exchanging, and processing data may be provided.

The internal IT system 1 may be connected to the security tool system 10, the network equipment 20, and the server/client 30 through an intranet, and may perform communication between them. In addition, the internal IT system 1 may be connected to the external IT system 200 through an external network (Internet network), and may perform communication between them.

Here, each of the networks may be implemented as any one type of wired/wireless networks, such as a local area network (LAN), a wide area network (WAN), a value-added network (VAN), a personal area network (PAN), a mobile communication network, or a satellite communication network.

In addition, the user terminal may be an individual device of any one among a computer, cellular phone, smart phone, smart pad, laptop computer, Personal Digital Assistants (PDA), Portable Multimedia Player (PMP), or at least one multi-device among shared devices such as a kiosk or a stationary display device installed in a specific place. Through this, the user terminal may use data transmission and reception services for IT resources provided by the internal IT system 1 and the external IT system 200.

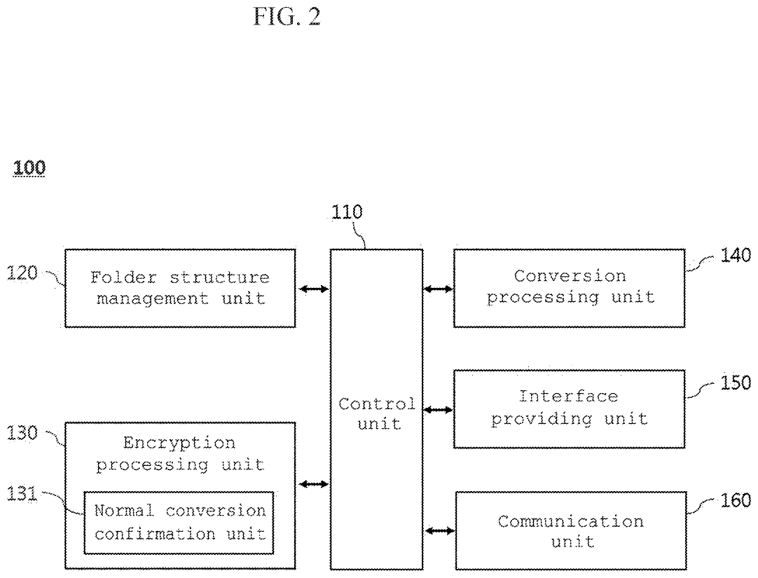

FIG. 2 is a block diagram showing a driving device according to an embodiment of the present invention in more detail.

Referring to FIG. 2, the driving device 100 of the security tool system 10 according to an embodiment of the present invention may include a control unit 110, a folder structure management unit 120, an encryption processing unit 130, a conversion processing unit 140, an interface providing unit 150, and a communication unit 160. Additionally, the encryption processing unit 130 may include a normal conversion confirmation unit 131.

As described above, the driving device 100 according to an embodiment of the present invention may be an operation control device mounted on the security tool system 10 to control driving of the security tool system 10, and may be configured of one or more hardware modules for this purpose and software modules for operating the same.

First, the control unit 110 controls driving of folders and file systems of the security tool system 10 and may be implemented as one or more processors for overall control of the operation of each component of the driving device 100. For example, the control unit 110 of the driving device 100 may include one or more microprocessor-based driving circuits, which implement in hardware all or some of software operating system functions that operate a network firewall, web firewall, anti-DDOS, network access control (NAC), intrusion prevention system (IPS), spam mail blocking system, and the like according to driving of the security tool system 10.

Subsequently, the folder structure management unit 120 may manage folder structure conversion information of the security tool system 10. The folder structure conversion information may be generated according to an encryption process previously performed by the encryption processing unit 130. In addition, the folder structure conversion information may include conversion tree structure information obtained by converting the original folder tree structure of the security tool system 10. Additionally, the folder structure conversion information may include original folder tree structure information mapped to the conversion tree structure information.

The folder structure management unit 120 may provide a hierarchical storage system using a folder tree structure in order to uniquely express a path to the location of a file existing in a storage device provided in the security tool system 10. Through this, the folder structure management unit 120 may guarantee a unique path using the hierarchical storage system when a change such as expansion or contraction of the folder tree structure is performed. The hierarchical storage system may designate or allocate text such as characters, numbers, symbols, and the like that can be assigned to a folder name generated in each folder tree structure, and generate a non-authorization event for duplicate or unauthorized text to limit use of the text.

For reference, files may be classified into data files, program files, system files, and the like. Among them, the system files may be managed by an operating system installed to control hardware and software provided according to the object of operating the security tool system.

The folder structure management unit 120 may separately manage original folder tree structure information using the hierarchical storage system. The folder structure management unit 120 may manage the original folder tree structure information as a default tree structure and store it in a non-volatile memory. The folder structure management unit 120 may block access of a data deletion and change process to the original folder tree structure information, which is a default tree structure.

The folder structure management unit 120 may manage the default tree structure, in which related data files are located, as the original folder tree structure information so that processes needed for driving the security tool system 10 and providing functions thereof may be performed.

In this way, the folder structure management unit 120 may map the folder structure conversion information acquired according to expansion, contraction, conversion, and the like of the folder tree structure when an event related to change of the folder tree structure occurs on the basis of the original folder tree structure information. Through this, the folder structure conversion information may normally track the path of a file reading command requested from the inside of the security tool system 10.

The folder structure management unit 120 may store and manage the folder structure conversion information on a random-access memory configured in the security tool system 10. In response to the file reading command, the folder structure management unit 120 may search the folder structure conversion information residing on the random-access memory, and acquire a file location path from which a file may be read.

When the security tool system 10 is booted, the folder structure management unit 120 may store and activate the folder structure conversion information on the random-access memory. In contrast, information on the original tree structure may be stored on a non-volatile memory and managed as master information.

The encryption processing unit 130 may acquire a conversion tree structure obtained by converting the original folder tree structure by executing an encryption process. The original folder tree structure and the conversion tree structure may be stored as folder structure conversion information and managed by the folder structure management unit 120. The encryption process may include a process of mapping the original folder tree structure information to the randomly encrypted conversion tree structure.

In the encryption process, arbitrary text may be input and converted in each folder name included in the original folder tree structure information through a random encryption process. In addition, the encryption process may generate a secondary conversion tree structure even for the primarily processed conversion tree structure when a conversion event occurs by converting each folder name through a random encryption process performed on the folder name.

At this point, in the encryption process, target folders, of which the folder name is to be changed, may be selected from the folder tree structure, and the minimum or maximum number of target folders to be changed may be set. In addition, in the encryption process, the type of text to be applied to the folder name and the minimum or maximum length of the selected text may be set. In addition, in the encryption process, whether to change a specific part of an existing folder name or to change the entire existing folder name may be set. In this way, the encryption process may change the setting of the scope and form of a target to be changed in the original folder tree structure.

In this way, the encryption process may be performed in a random encryption processing method to set the folder structure or the scope and form of changing folder names. Additionally, the encryption process may be applied in a method of exchanging and mixing folder names between folders by utilizing currently assigned folder names.

The random encryption process may include an encryption process of generating the conversion tree structure by randomly changing at least one among the depth or the path name of the original folder tree structure information. For example, the random encryption process may generate a conversion tree structure from the original folder tree structure having folder ‘2’, which is a subfolder of top-level folder ‘1’, and file ‘123.sys’ in folder ‘3’, which a subfolder of folder ‘2’, in the original folder tree structure information by changing folder ‘1’ to folder ‘A’, folder ‘2’ to folder ‘A2’, and folder ‘3’ to folder ‘A3’. In addition, the random encryption process may generate a conversion tree structure that converts to a path where file ‘123.sys’ is located in folder ‘A4’ by generating folder' ‘A4’ under the converted folder ‘A3’.

In addition, the encryption processing unit 130 may process a chain conversion on the conversion tree structure acquired by initially converting the original folder tree structure. For example, the encryption processing unit 130 may acquire a first conversion tree structure obtained by converting the original folder tree structure. Subsequently, the encryption processing unit 130 may acquire a second conversion tree structure by performing an encryption process on the first conversion tree structure. In this way, the [n]-th conversion tree structure may be converted into the [n+1], [n+2], [n+3], . . . , [n+m]-th conversion tree structures according to execution of the encryption process.

The encryption process may be repeatedly performed for each first period elapsed according to driving of the security tool system 10. In addition, the encryption process may be performed according to a set value input according to a manager's regular inspection schedule, or may be immediately executed on an irregular basis as needed. As the encryption process generates and applies a conversion tree structure periodically or as needed, external intrusion that may occur due to leakage of folder structure information or risk of malicious system access by insiders can be prevented in advance by enhancing security, and stability of the internal system can be guaranteed.

The encryption processing unit 130 may include a normal conversion confirmation unit 131. The normal conversion confirmation unit 131 may cancel a work in progress when an error occurs in the conversion tree structure mapped to the original folder tree structure information or the path to a file is not a unique path. The normal conversion confirmation unit 131 may confirm whether there is an abnormality by determining consistency with the existing tree structure before the conversion tree structure is finally stored in the folder structure conversion information.

According to an embodiment of the present invention, the encryption processing unit 130 may generate a conversion tree structure as described below. A disk, which is a specific storage device, may be configured of an original folder tree structure, which has ‘A1’, ‘A2’, and ‘A3’ as top-level folders, folders ‘B11’ and ‘B12’ under folder ‘A1’, folder ‘B21’ under folder ‘A2’, and folders ‘B31’, ‘B32’, and ‘B1’ under folder ‘A3’. The encryption processing unit 130 may convert the original folder tree structure as shown below by executing an encryption process. The encryption processing unit 130 may convert only folder ‘A1’ into ‘B1’ through a random encryption process of the encryption process. The encryption processing unit 130 may acquire a conversion tree structure having folders ‘B11’ and ‘B12’ under folder ‘B1’, folder ‘B21’ under folder ‘A2’, and folders ‘B31’, ‘B32’, and ‘B1’ under folder ‘A3’ through the encryption process. At this point, although the normal conversion confirmation unit 131 acquires ‘B1’, ‘A2’, and ‘A3’ as top-level folders, the folder name of top-level folder ‘B1’ may be the same as that of folder ‘B1’, which is a subfolder of folder ‘A3’. At this point, consistency may be determined according to the condition of the normal conversion confirmation unit 131 for securing a unique path. When the normal conversion confirmation unit 131 restricts use of duplicate folder names as a consistency determination condition, the work on the conversion tree structure of converting to ‘B1’ may be canceled and returned to the original folder name structure. The normal conversion confirmation unit 131 may approve and manage the conversion tree structure in the folder structure conversion information under the setting of approving duplication of folder names in different layers on the basis of an absolute path to a file as the consistency determination condition.

In this way, when conversion to the original tree structure is requested, such as when an error occurs during the folder structure conversion or when the user's input for folder structure encryption corresponds to a Roll-Back command, the encryption processing unit 130 may perform a rollback function using the master information, which is the original tree structure, and return the folder structure to the original tree structure.

The conversion processing unit 140 may convert the path of the file reading command requested from the inside of the security tool system 10 on the basis of the folder structure conversion information.

According to an embodiment of the present invention, the original folder tree structure may be configured of ‘dir1’, ‘dir2’, and ‘dir3’ as the top-level folders, ‘dir11’, ‘dir12’, and ‘dir13’ as subfolders of ‘dir1’, ‘dir21’, ‘dir22’, and ‘dir23’ as subfolders of ‘dir2’, and ‘dir31’ and ‘dir22’ as subfolders of ‘dir3’. Additionally, ‘dir41’ and ‘dir42’ are configured as subfolders of ‘dir31’, and execution file ‘setup.exe’ may located in ‘dir41’. When ‘/’ is used as a delimiter for separating upper and lower folders, the full path of execution file ‘setup.exe’ may be expressed as ‘dir3/dir31/dir41’. At this point, according to an input for folder structure encryption, the encryption processing unit 130 performs an encryption process to change folder names such as folder ‘dir3’ to ‘change3’, folder ‘dir31’ to ‘change31’, and folder ‘dir41’ to ‘change41’ and acquire conversion tree structure information included in the folder structure conversion information. Through this, when file ‘setup.exe’ is to be called by a process involved in driving the security tool system, the execution file may be called and executed through file path ‘change3/change31/change41’ instead of existing path of ‘dir3/dir31/dir41’. In addition, the folder structure conversion information resides in random-access memory, and a file path for a file to be read through the ‘setup.exe’ file may be obtained by mapping the file path to the folder structure conversion information of the random-access memory. As the path of a file used by the ‘setup.exe’ and a specific process is also converted as described above, the folder structure conversion information may block access to the execution file by external intruders or internal users with a malicious intention, who know the initial folder tree structure information configured in the security tool system, and in addition, system files or environment setting files that can control the functions of security tools may also be protected.

The interface providing unit 150 may output a manager interface according to driving of the security tool system 10 to process a previously performed encryption process. The previously performed encryption process may be processed according to a user's input for folder structure encryption corresponding to the manager interface. The input for folder structure encryption may include an immediate execution command or a repetition cycle setting command of the encryption process.

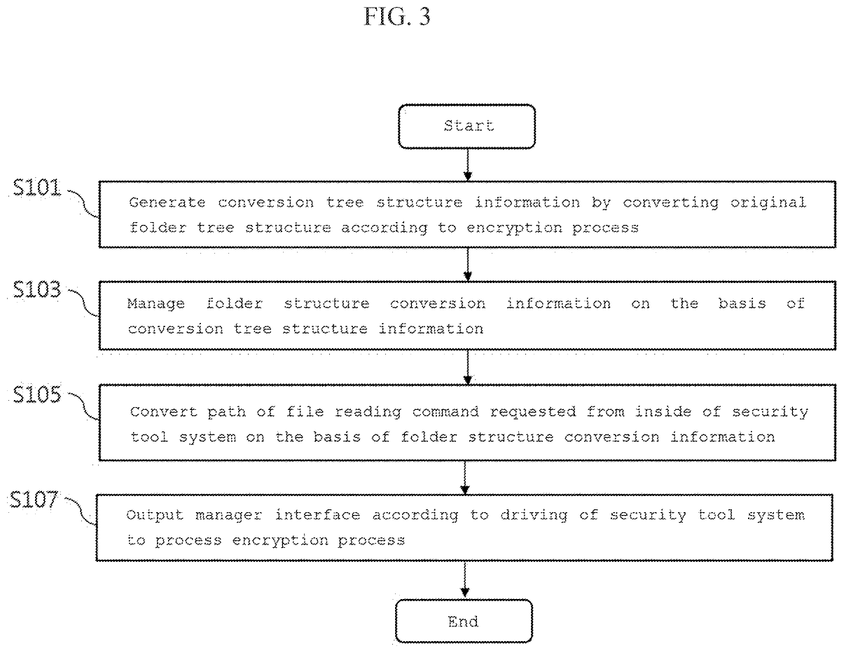

FIG. 3 is a flowchart illustrating an operation method of a driving device according to an embodiment of the present invention.

Referring to FIG. 3, in the operation method of a driving device of a security tool system for providing a folder protection function, at an encryption processing step (S101), conversion tree structure information may be generated by converting the original folder tree structure according to the encryption process of the security tool system 10.

At a folder structure management step (S103), folder structure conversion information of the security tool system 10 may be managed on the basis of the conversion tree structure information. At the folder structure management step (S103), the folder structure conversion information may be stored and managed on the random-access memory of the security tool system. The folder structure conversion information is generated when the security tool system 10 is booted, and stored on the random-access memory in a volatile manner.

The folder structure conversion information is generated according to the encryption process previously performed at the encryption processing step (S101), and may include the conversion tree structure information and the original folder tree structure information mapped to the conversion tree structure information. The previously performed encryption process may include a process of mapping the original folder tree structure information to the randomly encrypted conversion tree structure. The random encryption process may include an encryption process of generating the conversion tree structure by randomly changing at least one among the depth and the path name of the original folder tree structure information.

The previously performed encryption process may be repeatedly performed at each first cycle elapsed according to driving of the security tool system 10.

At a conversion processing step (S105), the path of the file reading command requested from the inside of the security tool system may be converted on the basis of the folder structure conversion information.

At an interface providing step (S107), a manager interface according to driving of the security tool system 10 may be output to process a previously performed encryption process. The previously performed encryption process may be processed according to a user's input for folder structure encryption corresponding to the manager interface. The input for folder structure encryption may include an immediate execution command or a repetition cycle setting command of the encryption process.

The methods according to the present invention described above may be manufactured as a program to be executed on a computer and stored in a computer-readable recording medium, and examples of the computer-readable recording medium include ROM, RAM, CD-ROM, magnetic tapes, floppy disks, optical data storage devices and the like.

The computer-readable recording medium may be distributed in computer systems connected through a network, so that computer-readable codes may be stored and executed in a distributed manner. In addition, functional programs, codes, and code segments for implementing the method may be easily inferred by the programmers in the art to which the present invention belongs.

In addition, although preferred embodiments of the present invention have been illustrated and described above, the present invention is not limited to the specific embodiments described above, and various modified embodiments can be made by those skilled in the art without departing from the gist of the invention claimed in the claims, and in addition, these modified embodiments should not be individually understood from the spirit or perspective of the present invention.

1. A driving device that drives a security tool system, the device comprising:
a folder structure management unit for managing folder structure conversion information of the security tool system; and
a conversion processing unit for converting a path of a file reading command requested from inside of the security tool system on the basis of the folder structure conversion information.

2. The device according to claim 1, wherein the folder structure conversion information is generated according to an encryption process previously performed by an encryption processing unit, and includes conversion tree structure information obtained by converting an original folder tree structure of the security tool system, and original folder tree structure information mapped to the conversion tree structure information.

3. The device according to claim 2, wherein the previously performed encryption process includes a process of mapping the original folder tree structure information to the randomly encrypted conversion tree structure.

4. The device according to claim 3, wherein the random encryption process includes an encryption process of generating the conversion tree structure by randomly changing at least one among a depth or a path name of the original folder tree structure information.

5. The device according to claim 3, wherein the previously performed encryption process is repeatedly performed at each first cycle elapsed according to driving of the security tool system.

6. The device according to claim 3, further comprising an interface providing unit for outputting a manager interface according to driving of the security tool system in order to process the previously performed encryption process, wherein the previously performed encryption process is processed according to a user's input for folder structure encryption corresponding to the manager interface.

7. The device according to claim 6, wherein the input for folder structure encryption includes an immediate execution command or a repetition cycle setting command of the encryption process.

8. The device according to claim 1, wherein the folder structure management unit stores and manages the folder structure conversion information on a random-access memory of the security tool system.

9. The device according to claim 8, wherein the folder structure conversion information is generated when the security tool system is booted, and stored on the random-access memory in a volatile manner.

10. A driving method of a driving device that drives a security tool system, the method comprising:
an encryption processing step of generating conversion tree structure information by converting an original folder tree structure according to an encryption process of the security tool system;
a folder structure management step of managing folder structure conversion information of the security tool system on the basis of the conversion tree structure information; and
a conversion processing step of converting a path of a file reading command requested from inside of the security tool system on the basis of the folder structure conversion information.

11. The method according to claim 10, wherein the folder structure conversion information is generated according to an encryption process previously performed at the encryption processing step, and includes the conversion tree structure information, and original folder tree structure information mapped to the conversion tree structure information.

12. The method according to claim 11, wherein the previously performed encryption process includes a process of mapping the original folder tree structure information to the randomly encrypted conversion tree structure.

13. The method according to claim 12, wherein the random encryption process includes an encryption process of generating the conversion tree structure by randomly changing at least one among a depth or a path name of the original folder tree structure information.

14. The method according to claim 12, wherein the previously performed encryption process is repeatedly performed at each first cycle elapsed according to driving of the security tool system.

15. The method according to claim 12, further comprising an interface providing step of outputting a manager interface according to driving of the security tool system in order to process the previously performed encryption process, wherein the previously performed encryption process is processed according to a user's input for folder structure encryption corresponding to the manager interface.

16. The method according to claim 15, wherein the input for folder structure encryption includes an immediate execution command or a repetition cycle setting command of the encryption process.

17. The method according to claim 10, wherein at the folder structure management step, the folder structure conversion information is stored and managed on a random-access memory of the security tool system.

18. The method according to claim 17, wherein the folder structure conversion information is generated when the security tool system is booted, and stored on the random-access memory in a volatile manner.
